(19) United States
(12) Patent Application Publication
(10) Pub. No.: US 2006/0223932 A1
(43) Pub. Date: Oct. 5, 2006

(54) Pigment composition for plastics

(76) Inventors: Manfred Kieser, Darmstadt (DE); Emil F. Aust, Mainz (AT)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/567,844

(22) PCT Filed: Jul. 16, 2004
(86) PCT No.: PCT/EP04/07937

§ 371 Date: Feb. 10, 2006

(30) Foreign Application Priority Data
Aug. 13, 2003 (DE) 10337188.5

(51) Int. Cl. C09C 1/00

(52) U.S. Cl. 524/449; 106/415

(57) ABSTRACT

The present invention relates to pigment compositions for the pigmentation of plastics, characterised in that one or more flake-form effect pigments are mixed with an at least partially polar carrier material, to a process for the preparation of the pigment compositions, and to the use thereof for the pigmentation of plastics and for the production of masterbatches.

The present invention relates to pigment compositions for the pigmentation of plastics, characterised in that one or more flake-form effect pigments are mixed with an at least partially polar carrier material, to a process for the preparation of the pigment compositions, and to the use thereof for the pigmentation of plastics and for the production of masterbatches.

The poor flow behaviour of flake-form pigments, such as, for example, mica, has been known for a long time. In many applications, in particular in the printing and paints sectors, this does not result in serious problems. On incorporation into plastics, however, the poor flow behaviour of these pigments proves to be problematic.

In addition, pronounced formation of dust takes place during the processing of pearlescent pigments, for example in the production of masterbatches, which requires increased equipment complexity for removing the dusts and for cleaning the machines.

U.S. Pat. No. 6,451,102 proposes the sheathing of pearlescent pigments with waxes, preferably with polyethylene wax. The pearlescent pigments sheathed with these waxes exhibit good flow behaviour and can be employed for the production of masterbatches. However, it is found that pearlescent pigments sheathed with polyethylene wax are only suitable for incorporation into nonpolar plastics, such as, for example, polyolefins. This applies equally to the masterbatches described therein. Polar plastics can only be pigmented poorly with these sheathed pearlescent pigments. On production of masterbatches from pearlescent pigments sheathed with nonpolar materials and polar plastics, compatibility problems arise. This can lead in the end product to, inter alia, defects in the achievable visible lustre effects, to colour shifts and to unacceptable changes in the mechanical properties of the finished products. Even if some compatibility with a few plastics is present, problems arise on use of other plastics, since none of the waxes readily covers the entire range of polar plastics. The compatibility problems can also result in difficulties during masterbatch production itself. If, for example, the melt viscosity drops considerably during masterbatch production on changing from natural material to masterbatch, this can result in extrudate tearing during extrusion, which is extremely problematic for the producer.

The object was therefore to provide pigment compositions which are readily flowable, do not dust, have great variability in relation to the plastics into which they can be incorporated and allow an increase in the machine throughput during extrusion in twin-screw extruders or the production of highly concentrated masterbatches in single-screw extruders.

The complex object mentioned above is achieved by the pigment composition according to the invention.

The invention therefore relates to a pigment composition for the pigmentation of plastics, in which one or more flake-form effect pigments are mixed with an at least partially polar carrier material. The present invention furthermore relates to a process for the preparation of the pigment composition according to the invention in which one or more flake-form effect pigments are mixed with an at least partially polar carrier material with inflow of heat. This invention likewise relates to the use of the pigment composition according to the invention for the pigmentation of plastics and for the production of masterbatches. The pigment composition according to the invention based on flake-form effect pigments and an at least partially polar carrier material proves to be particularly advantageous for incorporation into plastics, in particular for polar plastics. However, the only partially polar character of the carrier material also enables adaptation for incorporation into nonpolar plastics. This variability cannot be achieved by pigment compositions from the prior art and is an essential advantage of the present invention. The user is thus given the possibility of pigmenting a plurality of different plastics with only one appropriately selected pigment composition according to the invention. In addition, the pigment compositions according to the invention are non-dusting and very readily flowable, which reduces the equipment complexity during their processing. In addition, on use of the pigment compositions according to the invention in a twin-screw extruder, the throughput can be increased, depending on the conditions, by a factor of at least 2-5 compared with the pigment on its own. Furthermore, use of the pigment composition according to the invention in a single-screw extruder enables the production of masterbatches having an effect pigment content of up to 40% by weight, based on the masterbatch.

An essential constituent of the pigment composition according to the invention is the at least partially polar carrier material. The at least partially polar carrier material can be a partially polar copolymer and/or a mixture of two or more waxes, where at least one of the waxes is polar. The partially polar carrier material is preferably a partially polar copolymer and/or a mixture of two polar waxes.

The term copolymers is taken to mean polymers formed from more than one type of monomer. Suitable for the pigment composition according to the invention are bipolymers, tripolymers or quaterpolymers, as well as alternating, random, gradient, block or graft copolymers. Suitable copolymers for the purposes of the present invention are those which are at least partially polar, i.e. at least one monomer of the copolymer is polar. Suitable partially polar copolymers are, for example, copolymers and terpolymers with vinyl acetate, acrylate or acrylic acid comonomers, polyvinyl alcohol copolymers, polyvinyl ether copolymers, polyvinylpyrrolidone copolymers, polyethylene oxide copolymers, acrylonitrile copolymers, methyl methacrylate copolymers, polyacetal copolymers, but also polyamide copolymers and/or polyurethane copolymers. Examples of copolymers which can be employed are ethylene-vinyl acetate copolymers, ethylene-acrylic acid copolymers and ethylene-vinyl alcohol copolymers.

Suitable waxes for the mixture of two or more waxes are all waxes known to the person skilled in the art, which can be natural, chemically modified or synthetic waxes. At least one of the waxes present in the mixture of two or more waxes is polar. The mixture is preferably a mixture of two polar waxes, such as, for example, montan waxes and derivatives thereof and amide waxes, which may also have a nonpolar component, for example constituents containing alkyl chains, but are polar overall.

In a particularly preferred embodiment, the carrier material employed is a partially polar copolymer. Preferred copolymers here are, in particular, ethylene-vinyl acetate copolymers and ethylene-acrylic acid copolymers. Mixtures of montan waxes and derivatives thereof with amide waxes are likewise particularly preferred as carrier material, where the ratio of montan waxes to amide waxes can be from 2:1 to 1:2, in particular 1:1.

In the pigment composition according to the invention, the flake-form effect pigments and the partially polar carrier material are in the form of a mixture with one another. The flake-form effect pigment is preferably at least partially or completely coated or sheathed with the carrier material. Complete sheathing with and “sticking” of the flake-form effect pigment to the carrier material are very particularly preferred.

The melting range of the at least partially polar carrier material should be between 70 and 200° C., preferably between 80 and 160° C. and very particularly preferably between 90 and 140° C.

The flake-form effect pigments in the present invention can be pearlescent pigments, metal-effect pigments, multilayered pigments having transparent, semi-transparent and/or opaque layers, holographic pigments, BiOCl pigments and/or LCP pigments.

Pearlescent pigments, metal-effect pigments or multilayered pigments having transparent, semi-transparent and/or opaque layers which can be employed in accordance with the present invention are based, in particular, on supports, which are preferably in flake form. For example, flake-form TiO₂, synthetic or natural mica, glass flakes, metal flakes, flake-form SiO₂, Al₂O₃ or flake-form iron oxide are suitable. The metal flakes can consist, inter alia, of aluminium, titanium, bronze, steel or silver, preferably aluminium and/or titanium. The metal flakes here may have been passivated by corresponding treatment. In a preferred embodiment, the support may have been coated with one or more transparent, semi-transparent and/or opaque layers comprising metal oxides, metal oxide hydrates, metal suboxides, metals, metal fluorides, metal nitrides, metal oxynitrides or mixtures of these materials. The metal oxide, metal oxide hydrate, metal suboxide, metal, metal fluoride, metal nitride or metal oxynitride layers or the mixtures thereof can have low refractive indexes (refractive index<1.8) or high refractive indexes (refractive index=1.8). Suitable metal oxides and metal oxide hydrates are all metal oxides and metal oxide hydrates known to the person skilled in the art, such as, for example, aluminium oxide, aluminium oxide hydrate, silicon oxide, silicon oxide hydrate, iron oxide, tin oxide, cerium oxide, zinc oxide, zirconium oxide, chromium oxide, titanium oxide, in particular titanium dioxide, titanium oxide hydrate and mixtures thereof, such as, for example, ilmenite or pseudobrookite. Metal suboxides which can be employed are, for example, the titanium suboxides. Suitable metals are, for example, chromium, aluminium, nickel, silver, gold, titanium, copper or alloys, and a suitable metal fluoride is, for example, magnesium fluoride. Metal nitrides or metal oxynitrides which can be employed are, for example, the nitrides or oxynitrides of the metals titanium, zirconium and/or tantalum. Preference is given to the application of metal oxide, metal, metal fluoride and/or metal oxide hydrate layers and very particularly preferably metal oxide and/or metal oxide hydrate layers to the support. Furthermore, multilayered structures comprising high- and low-refractive-index metal oxide, metal oxide hydrate, metal or metal fluoride layers may also be present, preferably with high- and low-refractive-index layers alternating. Particular preference is given to layer packages comprising a high-refractive-index layer and a low-refractive-index layer, it being possible for one or more of these layer packages to be applied to the substrate. The sequence of the high- and low-refractive-index layers can be matched to the support here in order to include the support in the multilayered structure. In a further embodiment, the metal oxide, metal oxide hydrate, metal suboxide, metal, metal fluoride, metal nitride or metal oxynitride layers can be mixed or doped with colorants or other elements. Suitable colorants or other elements are, for example, organic or inorganic coloured pigments, such as coloured metal oxides, for example magnetite, chromium oxide or coloured pigments, such as, for example, Berlin Blue, ultramarine, bismuth vanadate, Thenard's Blue, or alternatively organic coloured pigments, such as, for example, indigo, azo pigments, phthalocyanines or alternatively Carmine Red, or elements, such as, for example, yttrium or antimony. Effect pigments comprising these layers exhibit a wide variety of colours with respect to their mass tone and can in many cases exhibit an angle-dependent change in the colour (colour flop) due to interference. In a preferred embodiment, the outer layer on the support is a high-refractive-index metal oxide. This outer layer may additionally be on the above-mentioned layer packages or may be part of a layer package in high-refractive-index supports and can, for example, consist of TiO₂, titanium suboxides, Fe₂O₃, SnO₂, ZnO, ZrO₂, Ce₂O₃, CoO, Co₃O₄, V₂O₅, Cr₂O₃ and/or mixtures thereof, such as, for example, ilmenite or pseudobrookite. TiO₂ is particularly preferred.

Examples and embodiments of the above-mentioned materials and pigment structures are also given, for example, in Research Disclosures RD 471001 and RD 472005, the disclosure content of which is incorporated herein by way of reference.

The thickness of the metal oxide, metal oxide hydrate, metal suboxide, metal, metal fluoride, metal nitride or metal oxynitride layers or a mixture thereof is usually from 3 to 300 nm and in the case of the metal oxide, metal oxide hydrate, metal suboxide, metal fluoride, metal nitride or metal oxynitride layers or a mixture thereof is preferably from 20 to 200 nm. The thickness of the metal layers is preferably from 4 to 50 nm.

The size of the supports and thus of the effect pigments is not crucial per se. Flake-form supports and/or flake-form supports coated with one or more transparent or semi-transparent metal oxide, metal or metal-fluoride layers generally have a thickness of between 0.05 and 5 μm, in particular between 0.1 and 4.5 μm. The dimension in the length or width is usually between 1 and 250 μm, preferably between 2 and 200 μm and in particular between 2 and 100 μm.

The proportion of flake-form effect pigments in the pigment composition according to the invention is generally between 60 and 85% by weight, preferably between 65 and 75% by weight, based on the pigment-composition. The optimum proportions can easily be determined by the person skilled in the art and depend essentially on the particle size of the effect pigments employed, the form factor of the effect pigments and the way in which the pigment is built up. The highest possible proportion of effect pigments or the lowest possible proportion of carrier material is desirable in order to incorporate as little foreign material as possible into the plastic to be pigmented. However, sufficient carrier material must be used to ensure the desired properties of the pigment composition according to the invention, such as, for example, non-dusting, improved flowability or higher throughput in masterbatch production. To this end, the particles must not only be sheathed with the carrier material, but must also be stuck to one another to form a readily flowable coarse “powder”.

In a further embodiment, the pigment composition can comprise further additives and/or auxiliaries as are conventional for use in plastics. Additives and/or auxiliaries of this type can be lubricants, release agents, stabilisers, antistatics, flame retardants, colorants, flexibilisers and plasticisers, adhesion promoters, blowing agents, antioxidants, UV absorbers, organic polymer-compatible solvents and/or surfactants, such as, for example, diisooctyl phthalate, phenol derivatives, mineral oils. An overview of the additives and auxiliaries which can be employed is given in Saechtling, Kunststoff Taschenbuch [Plastics Pocketbook], 27th Edition, Carl Hanser Verlag, or R. Wolf in “Plastics Additives” in Ullmann's Encyclopaedia of Industrial Chemistry, Internet Edition, 7th Edition, 2003.

The pigment composition according to the invention can be prepared in an uncomplicated manner. The present invention thus also relates to a process for the preparation of the pigment composition according to the invention in which one or more flake-form effect pigments are mixed with an at least partially polar carrier material with inflow of heat. The flake-form effect pigments which can be employed and the partially polar carrier material have already been mentioned above in the description of the pigment composition.

Thus, in accordance with the process according to the invention, the effect pigment can, for example, be initially introduced and mixed with the carrier material or the solution of the carrier material. If the carrier material is added in the form of a solution, the effect pigment can also be dispersed in this solution and the solvent evaporated. The choice of solvent is made in an obvious manner for the person skilled in the art taking into account the solubilities of the pigments employed and in particular of the carrier material employed. Precipitation of the carrier material from an aqueous dispersion by changing the pH is likewise possible. It is furthermore possible to prepare the pigment composition by melting the carrier material. Melting of the carrier material is particularly preferred in the present invention since it enables the use of solvents to be avoided.

The preparation of the pigment composition according to the invention by melting is carried out at temperatures of from 70 to 240° C. The process is preferably carried out at temperatures above the melting point of the carrier material. In this way, particularly good mixing of pigment and carrier material is achieved.

In a further embodiment of the process according to the invention, further additives and/or auxiliaries which are conventional in the processing of plastics can be added to the mixture of flake-form effect pigment and carrier material. Examples of additives and/or auxiliaries of this type have already been mentioned above in the description of the pigment composition.

After removal of the solvent or after cooling of the carrier material applied during melting, the pigment composition is in the form of a free-flowing, coarsely particulate powder which can be further processed well.

The present invention likewise relates to the use of the pigment composition according to the invention for the direct pigmentation of plastics and for the production of masterbatches.

Direct incorporation of the pigment composition according to the invention into the plastic is carried out by mixing the plastic granules and/or powder with the pigment composition. The plastic pigmented with the pigment composition according to the invention is subsequently shaped under the action of heat. Furthermore, further additives and pigments can optionally be added to the plastic granules and/or powder during incorporation of the pigment composition. Examples of additives of this type have already been mentioned above in the description of the pigment composition. Suitable pigments are all inorganic or organic pigments known to the person skilled in the art.

The plastic granules and/or powder/pigment mixture is generally prepared by a process in which the plastic granules and/or powder is/are introduced into a suitable mixer, for example drum or high-speed mixer, and wefted with any additives, and the pigment composition is then added and mixed in.

Suitable for use of the pigment composition according to the invention is a whole series of plastics, in particular thermoplastics. The plastics are preferably polar plastics, but it is also possible to employ nonpolar (olefinic) plastics given appropriately selected carrier materials. Examples of suitable plastics are given, for example, in Saechtling, Kunststoff Taschenbuch [Plastics Pocketbook], 27th Edition, Carl Hanser Verlag.

The pigment composition according to the invention can also advantageously be employed for the production of masterbatches. In this way, maximum demands of pigment dispersal can also be met. The masterbatches can be produced either continuously or batchwise, preferably continuously, for example through the use of twin-screw extruders. The use of powders or grit of the respective plastics is advantageous in the production of masterbatches. On use of the pigment compositions according to the invention in a twin-screw extruder, the throughput can be increased, depending on the conditions, by a factor of at least 2-5 compared with the pigment on its own. Furthermore, masterbatches having a pigment content of up to 40% by weight, based on the masterbatch, can be produced using the pigment composition according to the invention in a single-screw extruder.

The pigment composition according to the invention is preferably employed. for the production of masterbatches. Given an appropriate choice of carrier material, both polar and nonpolar plastics are suitable as masterbatch base. There are, for example, graft copolymers which can be employed as carrier material in effect-pigment compositions according to the invention both in polar and in nonpolar (olefinic) plastics. For example, ethyleneacrylic acid copolymers are suitable both for use in polar and for use in nonpolar plastics.

The following examples are intended to explain the invention in greater detail, but without limiting it.

### EXAMPLES

### Example 1

A homogeneous mixture of 15% by weight of a montan ester wax (Hostalub® WE 40, Clariant AG) and 15% by weight of an amide wax (Hostalub® FA 1, Clariant AG) is mixed with 70% by weight of Iriodin® Brilliant Pearl at a temperature of about 150° C. in a mixer until uniform distribution and bonding of pigment and carrier material have been achieved. The % by weight data are based on the mixture as a whole.

The pigment composition obtained no longer dusts, flows well and can be converted in a single-screw extruder into masterbatches comprising up to about 40% by weight of pigment, based on the total amount. The throughput with this composition in a twin-screw extruder can be increased, for the same pigment content, by a factor of at least 2-5 (compared with the pigment on its own). The composition can be incorporated without problems into various polar plastics (PA, PC, PMMA, PS, ABS, etc.).

### Example 2

A homogeneous mixture of 30% by weight of a low-molecular-weight ethylene-vinyl acetate copolymer (A-C 400 A, Honeywell Allied Signal) is mixed with 70% by weight of Iriodin® Brilliant Pearl at a temperature of about 150° C. in a mixer until uniform distribution and bonding of pigment and carrier material have been achieved. The % by weight data are based on the mixture as a whole.

The pigment composition obtained no longer dusts, flows well and can be converted in a single-screw extruder into masterbatches comprising up to about 40% by weight of pigment, based on the total amount. The throughput with this composition in a twin-screw extruder can be increased, for the same pigment content, by a factor of at least 2-5 (compared with the pigment on its own). The composition can be incorporated without problems into various polar plastics (PA, PC, PMMA, PS, ABS, etc.).

### Example 3

A homogeneous mixture of 20% by weight of a low-molecular-weight ethylene-vinyl acetate copolymer (A-C 400 A, Honeywell Allied Signal) is mixed with 80% by weight of Iriodin® 504 Red at a temperature of about 150° C. in a mixer until uniform distribution and bonding of pigment and carrier material have been achieved. The % by weight data are based on the mixture as a whole.

The pigment composition obtained no longer dusts, flows well and can be converted in a single-screw extruder into masterbatches comprising up to about 40% by weight of pigment, based on the total amount. The throughput with this composition in a twin-screw extruder can be increased, for the same pigment content, by a factor of at least 2-5 (compared with the pigment on its own). The composition can be incorporated without problems into various polar plastics (PA, PC, PMMA, PS, ABS, etc.).

### Example 4

A homogeneous mixture of 30% by weight of a low-molecular-weight ethylene-acrylic acid copolymer (A-C 540 A, Honeywell Allied Signal) is mixed with 70% by weight of Iriodin® 123 at a temperature of about 160° C. in a mixer until uniform distribution and bonding of pigment and carrier material have been achieved. The % by weight data are based on the mixture as a whole.

The pigment composition obtained no longer dusts, flows well and can be converted in a single-screw extruder into masterbatches comprising up to about 40% by weight of pigment, based on the total amount. The throughput with this composition in a twin-screw extruder can be increased, for the same pigment content, by a factor of at least 2-5 (compared with the pigment on its own). The composition can be incorporated without problems both into various polar plastics (PA, PC, PMMA, PS, ABS, etc.) and also into nonpolar (olefinic) plastics.

1. Pigment composition for the pigmentation of plastics, characterised in that one or more flake-form effect pigments are mixed with an at least partially polar carrier material.

2. Pigment composition according to claim 1, characterised in that the at least partially polar carrier material is a partially polar copolymer and/or a mixture of two or more waxes, where at least one of the waxes is polar.

3. Pigment composition according to claim 1, characterised in that the proportion of effect pigments, based on the pigment composition, is from 60 to 85% by weight.

4. Pigment composition according to claim 1, characterised in that the melting range of the carrier material is between 70 and 200° C.

5. Pigment composition according to claim 1, characterised in that the at least partially polar carrier material is a mixture of montan waxes and derivatives thereof and amide waxes.

6. Pigment composition according to claim 5, characterised in that the mixture of montan waxes and derivatives thereof and amide waxes is in the ratio from 1:2 to 2:1.

7. Pigment composition according to claim 1, characterised in that the copolymer is selected from the group consisting of the copolymers and terpolymers with vinyl acetate, acrylate or acrylic acid comonomers, polyvinyl alcohol copolymers, polyvinyl ether copolymers, polyvinylpyrrolidone copolymers, polyethylene oxide copolymers, acrylonitrile copolymers, methyl methacrylate copolymers, polyacetal copolymers, polyamide copolymers and/or polyurethane copolymers.

8. Pigment composition according to claim 1, characterised in that the copolymer is an ethylene-vinyl acetate copolymer or ethylene-acrylic acid copolymer.

9. Pigment composition according to claim 1, characterised in that the flake-form effect pigment is a pearlescent pigment, metal-effect pigment, multilayered pigment having transparent, semi-transparent and/or opaque layers, holographic pigment, BiOCl pigment and/or LCP pigment.

10. Pigment composition according to claim 1, characterised in that the pigment composition additionally comprises additives and/or auxiliaries.

11. Process for the preparation of a pigment composition according to claim 1, characterised in that one or more flake-form effect pigments are mixed with an at least partially polar carrier material with inflow of heat.

12. Process according to claim 11, characterised in that the at least partially polar carrier material is a partially polar copolymer and/or a mixture of two or more waxes, where at least one of the waxes is polar.

13. Process according to claim 11, characterised in that the mixing of the one or more flake-form effect pigments with an at least partially polar carrier material is carried out in solution or by melting.

14. Process according to claim 11, characterised in that the mixing of the one or more flake-form effect pigments and the at least partially polar carrier material is carried out at temperatures in the range from 70 to 240° C.

15. Process according to claim 11, characterised in that additives are additionally added to the mixture of flake-form effect pigment and carrier material.

16. Use of the pigment composition according to claim 1 for the pigmentation of plastics and for the production of masterbatches.
